(19) United States
(12) Patent Application Publication
(10) Pub. No.: US 2009/0057078 A1
(43) Pub. Date: Mar. 5, 2009

(54) REDUCED CAPACITANCE DAMPER AND METHOD

(76) Inventors: Nate Ellis, Marysville, OH (US); Richard Owens, Powell, OH (US); Lars David Moravy, Powell, OH (US)

Correspondence Address: CERMAK KENEALY & VAIDYA, LLP, 515 EAST BRADDOCK RD SUITE B, Alexandria, VA, 22314, US

(21) Appl. No.: 11/849,199

(22) Filed: Aug. 31, 2007

(51) Int. Cl. F16F 9/53

(52) U.S. Cl. 188/267.2

(57) ABSTRACT

A magneto rheological (MR) fluid damper system for use in a vehicle suspension system can include a twisted pair of conductors integrated into a hollow piston rod of the MR damper. The twisted pair of conductors provide a supply path for current to reach the actuating coil of the MR damper while also providing the current return path to an electric source. The twisted pair of conductors facilitates a reduction in capacitance in the operating circuit, and thus minimizes electromagnetic interference affecting other electrical systems in the vehicle.

### BACKGROUND

1. Field

The presently disclosed subject matter relates to a Magneto Rheological (MR) fluid damper system for use in a vehicle suspension system and its method of use. More particularly, the disclosed subject matter relates to an MR damper where electromagnetic interference (EMI) is reduced by reducing capacitance in the damper. For example, the conventional art current path that includes an integral return path through the damper itself can be replaced with a twisted pair of conductors.

2. Brief Description of the Related Art

Vehicle suspension systems utilize damping devices or shock absorbers for controlling the vibrations of the body and wheel due to road disturbances imposed on the mass-spring system of the vehicle body, wheels and suspension springs. A vehicle suspension damper usually provides a resistive force proportional to the relative velocity between the body and the wheel. Passive dampers may employ an oil-filled cylinder and piston arrangement, while active and controllable dampers may employ a magneto-rheological (MR) fluid-filled cylinder and piston arrangement where the viscosity of the MR fluid may be changed by the introduction of a magnetic field which in turn varies the amount of damping provided by the MR damper.

In recent years, hydraulic dampers have been utilizing MR fluid as part of vehicle suspension systems as vibration dampers. MR fluids respond to a magnetic field with a dramatic change in rheological behavior. These fluids can reversibly and instantaneously change from a free-flowing liquid to a semi-solid with controllable yield strength or therebetween when exposed to a magnetic field. In the absence of an applied field, MR fluids are reasonably well approximated as Newtonian liquids, but when an electric field is applied, the fluid becomes viscous and the viscosity increases as the potential of the electric field increases. One of the characteristics of MR fluid is that it changes its state very rapidly when an electric field is applied or released. This feature makes MR fluid a suitable element in hydraulic dampers. For most engineering applications, a simple Bingham plastic model is effective in describing the essential, field-dependent fluid characteristics.

Vehicle suspension systems that control damping by means of electric power, such as electronically powered actuators, generate various levels of conducted electromagnetic interference (EMI) or noise, which could interfere with other electrical devices in a vehicle such as radios and the like. This noise needs to be either contained or reduced. Noise is a problem that needs to be addressed, and several U.S. patents have attempted to solve this problem with respect to conventional art devices. These U.S. patents, listed below, are hereby incorporated in their entirety into this disclosure by reference.

For example, U.S. Pat. No. 6,926,288 (the '288 patent) discloses an electromagnetic interference filter for use in reducing electrical noise produced by an electrically actuated vehicle suspension system. In particular, the '288 patent discloses the use of a filter board that includes capacitors and inductors. The filter board is attached in series with the power switching mechanism for the electrically actuated vehicle suspension system such that noise generated by the switching mechanism can be suppressed from traveling back to the DC power source. Thus, the filter board of the '288 patent also prevents noise from interfering with the radio or other electrical components of the vehicle.

Similarly, U.S. Pat. No. 5,392,881 discloses a device for dampening vibratory motion that uses a thick housing for insulating other electronic equipment from the noise of the damper actuation.

There are several patents that utilize MR dampers, such as U.S. Pat. Nos. 6,637,556; 5,014,829; and 6,547,044. As shown in FIGS. 3a and 3b of the present application, one conventional type of MR damper includes a piston assembly 928 disposed in the damper body tube 914 which forms an annular flow gap 960 between the piston assembly 928 and the damper body tube 914. The piston assembly 928 is connected to a hollow piston rod 930 and is fixed in position within the housing tube 914. The piston assembly 928 has a piston core 946 mounted on one end of the piston rod 930 that is formed of a ferromagnetic material. The piston further includes a magnet assembly 948 including a coil 950 mounted on the piston core 946. The coil 950 is connected to an electrical source (not shown) via an electrical connector extending through the piston rod 930. The piston assembly 928 divides the volume of MR fluid within the damper body tube 914 into a compression chamber 964 and an extension chamber 966.

The current path to the coil 950 flows via an electrical connector 956 located within the piston rod 930. Typically, the piston rod 930 itself or possibly the sleeve 988, the tube 914, or other integral structure serves as the current return path.

The MR fluid within the damper body typically includes micron-sized ferrous particles dispersed in a fluid or an elastomer. When the MR fluid is exposed to a magnetic field, the liquid state is changed to semi-liquid or to a solid state. The speed of rheology is on the order of a millisecond. The yield stress of the semi-solid material has a relationship with magnetic field density. A desired damping effect between the sprung and unsprung masses of the vehicle is achieved by controlling the application of an electric current from the electronic control unit (ECU). The electrical current dictates the MR fluid's yield stress, which in turn determines damping resistance.

These types of MR dampers are well-suited to provide a controllable damping effect for the suspension system of a vehicle. One problem is that this kind of damper inherently contains parallel capacitance (due to the existence of the rod and the electrical conductor) which acts as a temporary short circuit, causing a large electrical current spike to travel down the control line, which acts as noise. This phenomenon occurs when the rod or other integral structure is used as a return path for the electrical current from the coil. By reducing capacitance in the damper, this noise can be reduced. One way to solve this problem is to add inductance to the ECU in series with the damper. However, this solution is expensive and introduces significant weight to the ECU.

However, the EMI problem, the weight problem, spacing problems, and other considerations have not been addressed in the aforementioned conventional art patents. Accordingly, there exists a need for an improved MR damper device in which the EMI is reduced, weight is minimized, spacing requirements are minimized, and other features and benefits are achieved that will be apparent to one of skill in the art from a reading of the description of the disclosed subject matter below.

### SUMMARY

In accordance with one aspect of the disclosed subject matter, a magneto rheological (MR) damper can include a cylinder tube that has a working chamber and a rebound chamber. The working and rebound chambers can include an MR fluid whose viscosity is controllable via a pulse width modulated current provided by a controller. A piston assembly can be attached to a hollow piston rod and housed within the cylinder tube. A flow gap can be formed between the piston assembly and the cylinder tube. Furthermore, the piston assembly can include a magnetic core and a flux ring positioned around the magnetic core. The flux ring provides a seal within the cylinder tube to separate the MR fluid in the working chamber from the MR fluid in the rebound chamber. A twisted pair of electrical conductors can be housed in the hollow piston rod. A coil can be mounted on the magnetic core for generating a magnetic field, wherein the coil is operatively interconnected to an electrical source via the twisted pair of electrical conductors extending through the piston rod. The twisted pair of electrical conductors provides an electrical return path to the electrical source.

In accordance with another aspect of the disclosed subject matter, there is provided a magneto rheological (MR) damper for reducing capacitance in a vehicle suspension system including a cylinder tube that has a working chamber and a rebound chamber. The working and rebound chambers contain an MR fluid. A piston assembly can be attached to a hollow piston rod and housed within the cylinder tube, wherein a flow gap is formed between the piston assembly and the cylinder tube. The piston assembly can include a magnetic core and a flux ring can be positioned around the magnetic core. The flux ring provides a seal within the cylinder tube to separate the MR fluid in the working chamber from the MR fluid in the rebound chamber. A twisted pair of electrical conductors can be housed in the hollow piston rod. A coil can be mounted on the magnetic core for generating a magnetic field, wherein the coil is operatively interconnected to an electrical source via the twisted pair of electrical conductors extending through the piston rod.

In accordance with still another aspect of the disclosed subject matter, the twisted pair of electrical conductors is connected to a 20 Hz FET driver.

In accordance with still another aspect of the disclosed subject matter, the magnetic field produced by the twisted pair of conductors during operation of the damper produces noise that is less than substantially 20 dBμV/539 KHz.

In accordance with still another aspect of the disclosed subject matter, there is provided a method of reducing capacitance and/or reducing electrical noise in a MR damper that can include passing an electrical current from the electrical source through the twisted pair of conductors extending through the hollow piston rod to the coil.

In accordance with another aspect of the disclosed subject matter, a magneto rheological damper system can include a working chamber, a rebound chamber in fluid communication with the working chamber, and an MR fluid located in at least one of the working chamber and the rebound chamber. A fluid communication structure configured to communicate the MR fluid between the working chamber and the rebound chamber can also be provided. A piston assembly including a piston and a hollow piston rod can be operatively connected to the piston, and a magnetic core can be located adjacent the fluid communicating structure. A coil can be located adjacent the magnetic core, and a twisted pair of electrical conductors can be located in the hollow piston rod and electrically connected to the coil to provide both a current supply path and current return path to and from the coil. Application of a current to the coil through the twisted pair of conductors can cause the coil to generate a magnetic field that affects the viscosity of the MR fluid.

In accordance with yet another aspect of the disclosed subject matter, the MR damper hollow piston rod can include an insulator material therein.

In accordance with yet another aspect of the disclosed subject matter, the fluid communication structure can be configured as a flux ring positioned around the magnetic core, and the flux ring can separate the MR fluid in the working chamber from the MR fluid in the rebound chamber.

In accordance with yet another aspect of the disclosed subject matter, the fluid communication structure can be integrated into the piston of the piston assembly.

Still other features and attendant characteristics of the disclosed subject matter will become apparent to those skilled in the art from a reading of the following detailed description of embodiments constructed in accordance therewith, and taken in conjunction with the accompanying drawings.

### BRIEF DESCRIPTION OF THE DRAWINGS

The disclosed subject matter will now be described in more detail with reference to exemplary embodiments of the apparatus and method, given only by way of example, and with reference to the accompanying drawings, in which:

FIG. 1a is a cross sectional representation of an embodiment of a MR damper made in accordance with principles of the disclosed subject matter;

FIG. 1b is an enlarged cross sectional representation of a portion of the MR damper of FIG. 1a;

FIG. 2a is a diagram illustrating the electrical current loop in a conventional MR damper;

FIG. 2b is a diagram illustrating the electrical current loop in an MR damper according to the present disclosed subject matter;

FIG. 3a is a cross sectional representation of a related art MR damper; and

FIG. 3b is an enlarged cross sectional representation of a portion of the related art MR damper of FIG. 3a having the rod as the return path for electric current from the damper coil back to the ECU.

### DETAILED DESCRIPTION OF EXEMPLARY EMBODIMENTS

Referring to the drawing figures, like reference numerals designate identical or corresponding elements throughout the several figures.

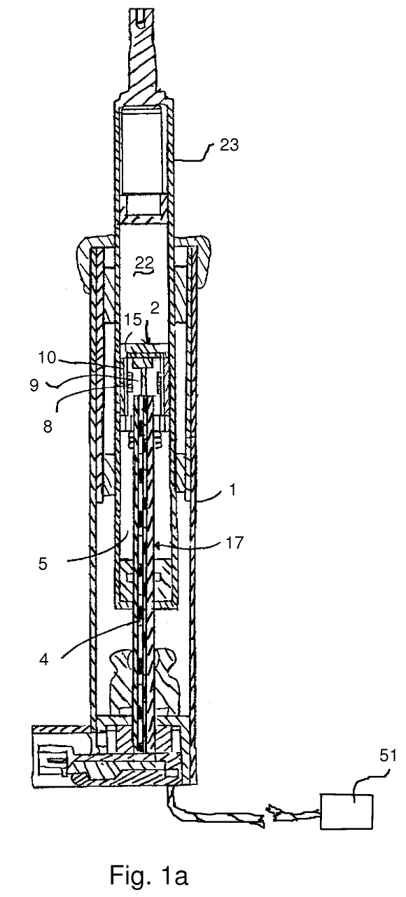

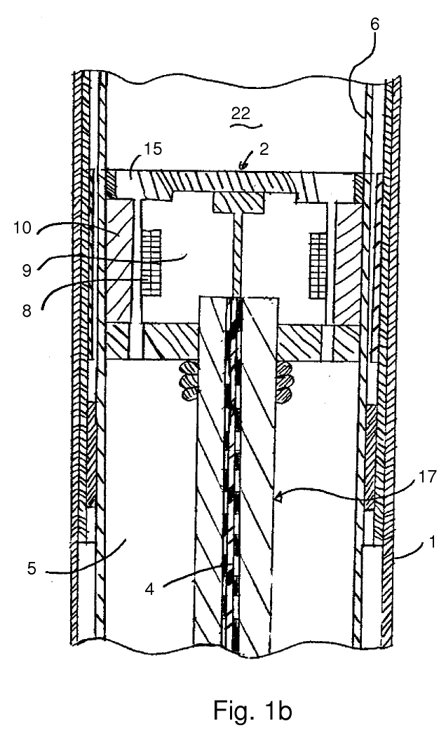

FIG. 1a is a cross sectional representation of an MR damper made in accordance with principles of the disclosed subject matter. FIG. 1b is an enlarged cross sectional representation of a portion of the MR damper of FIG. 1a. The MR damper can include a cylinder tube 1 that defines a compression chamber 22 and rebound chamber 5 for containing MR fluid. A piston assembly 2 can be attached to a hollow piston rod 17 and fixed in position within the cylinder tube 1. The piston assembly 2 includes a magnetic core 9, a flux ring 10, and a coil 8 mounted on the core 9. The piston assembly 2 divides the volume of MR fluid within the damper into the compression chamber 22 and rebound chamber 5, and acts to meter out the MR fluid between the chambers during operation. The coil 8 is connected to an electrical source via a twisted pair of conductors 4 extending through the hollow piston rod 17. The electrical power/signal source can be provided by an Electronic Control Unit (ECU) 51 located within the vehicle.

In the embodiment shown in FIG. 1b, the flux ring 10 positioned around the core 9 and includes a flow gap 15. The MR fluid can include microscopic particles of a magnetic material suspended in a liquid carrier. When the MR fluid is exposed to a magnetic field of sufficient strength, the suspended particles align with the magnetic field and cause a change of viscosity in the MR fluid. Thus, by controlling the application of electric current to the coil 8, the magnetic field is varied and the flow characteristics of the MR fluid are also affected. Thus, the flow of MR fluid through the flow gap 15 can be controlled in a predictable manner. In particular, the ECU 51 can be used to control the current supplied to the coil 8, which in turn creates a magnetic field to control the viscosity of the MR fluid. The ECU 51 can use a pulse width modulated signal at 20 KHz, for example, to control the current that is provided to the coil 8.

When large vibrations are sensed during travel of a vehicle, the ECU 51 can provide a current amount that causes the MR fluid in the MR damper to become more viscous, and therefore slow the fluid flow through the flow gap 15, and likewise slow the relative movement between the piston 2 and the damper tube 23. This action provides an effective and controlled damping to the vehicle.

During operation of the MR damper, electric current is supplied to the coil 8, wherein such application of electric current generates a magnetic field, as described above. The twisted pair of conductors 4 provides both the supply flow path and return path for current, such that electric current flows from the ECU, through the coil 8, and back to the ECU via the twisted pair of conductors 4. By using the twisted pair of conductors 4, the load capacitance in the damper can be significantly reduced as compared to conventional damper mechanisms, and thus the electromagnetic interference (i.e., noise) in the control line is reduced without requiring added inductance and its attendant space and weight requirements.

The twisted pair of conductors 4 may be wires constructed of steel, copper, aluminium, combinations of such materials, or other electrically conductive materials. The conductors 4 may optionally include insulator material, such as plastic, vinyl, or the like.

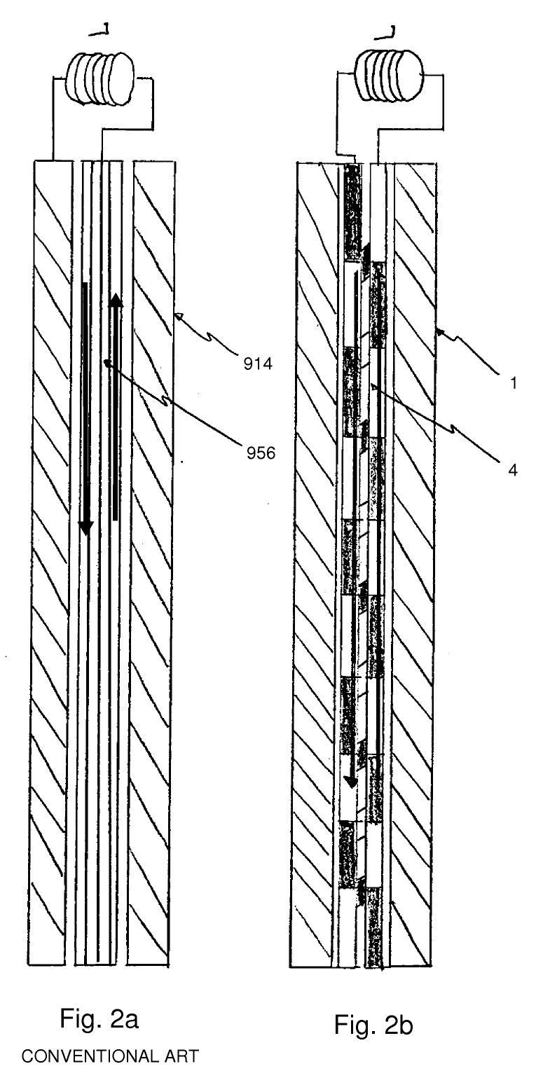

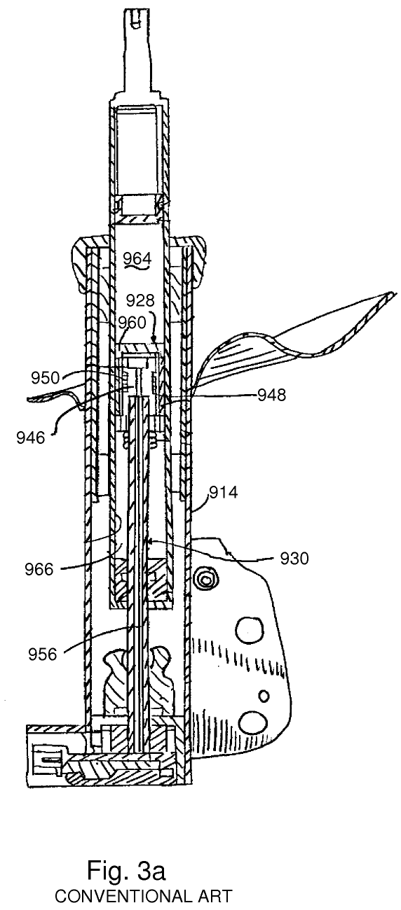

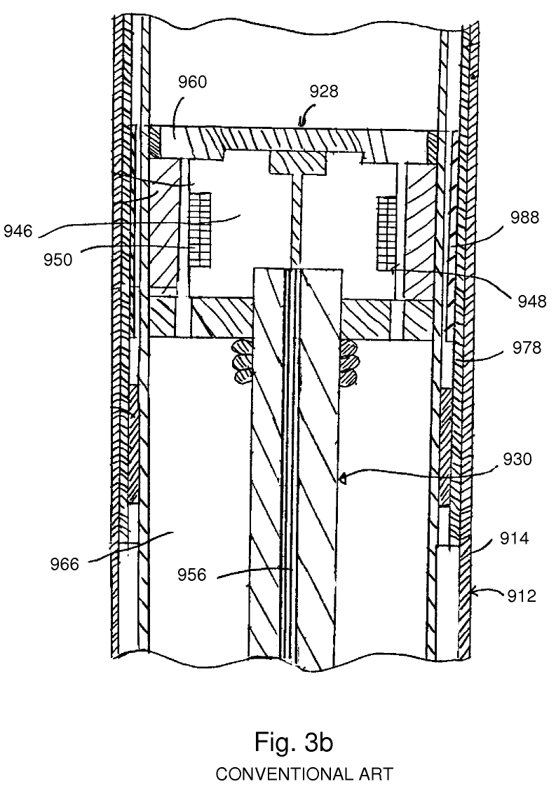

FIGS. 2a and 2b are diagrams illustrating a conventional current loop in an MR damper (FIG. 2a) as compared to an example of a current loop in an MR damper made in accordance with principles of the disclosed subject matter (FIG. 2b). The conventional art employs a single electrical conductor located in the piston rod and routes the return current path through the piston rod itself. In contrast, the damper as shown in FIG. 3b employs a pair of twisted conductors that provide both the current supply path and return path to and from a coil. One characteristic of the twisted pair of conductors is a reduction in capacitance as compared to the conventional art. This can be shown by the formula for capacitance:

C=εA/d,
where C=capacitance,
ε=permittivity,
A=area for plate overlap, and
d=distance between the plates.

As shown in FIG. 2b, an electric current from the ECU is conducted through the damper via a twisted pair of conductors. The current is returned to the source through the same twisted conductors. Thus, because the “plate overlap area” (A) is small for a twisted pair of conductors, the capacitance can be minimized. In addition, insulating covers can be provided on each conductor of the twisted pair of conductors to provide a distance (d) between each of the conductors such that, combined with the minimal plate overlap area A, capacitance is further minimized. In addition, theoretically, the twisted conductors should produce little or no interference and cancel out each other's noise characteristics due to their twisted nature. All of these factors taken in combination help to minimize the capacitance and the resultant noise generated by the electrical circuit for the MR damper.

Although certain embodiments of the disclosed subject matter are described above, it should be understood that the disclosed subject matter can be embodied and configured in many different ways without departing from the spirit and scope of the invention. For example, the fluid communication structure that regulates the amount and speed of MR fluid flow between the compression chamber and the rebound chamber can be formed on other structures besides the piston assembly. In particular, the cylinder wall can be provided with a fluid communication structure that has a flow gap to regulate the transfer of MR fluid between the compression chamber and the rebound chamber. In addition, a structure that is separate from both the piston assembly and cylinder could conceivably be used in an MR damper in which the compression chamber and rebound chamber are formed above the piston assembly or in another manner. In addition, the flux ring can include or comprise the fluid communication structure that communicates between the compression chamber and rebound chamber.

Alternate means for applying the magnetic field to the MR damper are contemplated. For example, a plurality of coils and/or cores can be provided to achieve the desired magnetic field onto the MR fluid.

The compression chamber and rebound chamber need not be above and below the piston as shown in the various exemplary figures, but could be arranged such that they both reside on one side of the piston, for example. In this case, the piston would push the MR fluid in to a reservoir style rebound chamber that receives MR fluid during compression and then drains the MR fluid back to the compression chamber during rebound.

The cylinders and other components of the MR damper can be made from metals, plastics or even ceramic materials. The cylinder materials, such as the ceramics materials, can further enhance the reduction in capacitance and resultant noise characteristics of the MR damper.

While the disclosed subject matter has been described in detail with reference to exemplary embodiments thereof, it will be apparent to one skilled in the art that various changes can be made, and equivalents employed, without departing from the scope of the invention. Each of the aforementioned conventional art documents is hereby incorporated by reference herein in its entirety.

What is claimed is:

1. A magneto rheological (MR) damper comprising:
a cylinder including a working chamber and a rebound chamber, wherein at least one of the working chamber and rebound chamber includes an MR fluid;
a hollow piston rod;
a piston assembly operatively connected to the hollow piston rod and housed within the cylinder, wherein a flow gap is formed by one of the cylinder and the piston assembly, and wherein the piston assembly includes,
a magnetic core, and
a coil located adjacent the magnetic core and configured to generate a magnetic field upon application of an electric current to the coil; and
a twisted pair of electrical conductors housed in the hollow piston rod, wherein the coil is configured to be connected to an electrical source via one of the twisted pair of electrical conductors that extend through the piston rod, and the other of the twisted pair of electrical conductors provides an electrical return path from the coil to the electrical source.

2. The MR damper of claim 1, further comprising:
a flux ring positioned adjacent the magnetic core, wherein the flux ring provides a seal within the cylinder to separate the MR fluid in the working chamber from the MR fluid in the rebound chamber.

3. The MR damper of claim 1, wherein the hollow piston rod includes an insulator material therein.

4. A method of reducing capacitance in a magneto rheological (MR) damper according to claim 1 comprising:
passing an electrical current from the electrical source through the twisted pair of conductors extending through the hollow piston rod to the coil.

5. A method of reducing electrical noise in a magneto rheological (MR) damper according to claim 1 comprising:
passing an electrical current from the electrical source through the twisted pair of conductors extending through the hollow piston rod to the coil.

6. A magneto rheological (MR) damper system, comprising:
a working chamber;
a rebound chamber in fluid communication with the working chamber;
an MR fluid located in at least one of the working chamber and the rebound chamber;
a fluid communication structure configured to communicate the MR fluid between the working chamber and the rebound chamber, a piston assembly including a piston and a hollow piston rod operatively connected to the piston;
a magnetic core located adjacent the fluid communicating structure;
a coil located adjacent the magnetic core; and
a twisted pair of electrical conductors located in the hollow piston rod and electrically connected to the coil to provide both a current supply path and current return path to and from the coil, wherein application of a current to the coil through the twisted pair of conductors causes the coil to generate a magnetic field that affects the viscosity of the MR fluid.

7. The MR damper system of claim 6, wherein the hollow piston rod includes an insulator material therein.

8. The MR damper system of claim 6, wherein the fluid communication structure is configured as a flux ring positioned around the magnetic core, and the flux ring separates the MR fluid in the working chamber from the MR fluid in the rebound chamber.

9. The MR damper system of claim 6, wherein the fluid communication structure is integrated into the piston of the piston assembly.

10. The MR damper system of claim 9, wherein the coil and magnetic core are integrated into the piston of the piston assembly.

11. The MR damper system of claim 6, wherein the coil and magnetic core are integrated into the piston of the piston assembly.

12. A method of reducing electrical noise in a magneto rheological (MR) damper according to claim 6 comprising:
passing an electrical current through the twisted pair of conductors extending through the hollow piston rod to the coil.
